(19) United States
(12) Patent Application Publication
(10) Pub. No.: US 2020/0181466 A1
(43) Pub. Date: Jun. 11, 2020

(54) RESIN AND HOT MELT ADHESIVE

(71) Applicant: INDUSTRIAL TECHNOLOGY RESEARCH INSTITUTE, Hsinchu (TW)

(72) Inventors: Chao-Chieh CHIANG, Kaohsiung City (TW); Yi-Che SU, Zhubei City (TW); De-Lun KUO, Hsinchu City (TW)

(73) Assignee: INDUSTRIAL TECHNOLOGY RESEARCH INSTITUTE, Hsinchu (TW)

(21) Appl. No.: 16/231,768

(22) Filed: Dec. 24, 2018

(30) Foreign Application Priority Data
Dec. 6, 2018 (TW) 107143845

(51) Int. Cl. C09J 175/06; C09J 175/08; C08G 18/72; C08G 18/42; C08G 18/48

(52) U.S. Cl. CPC C09J 175/06; C09J 175/08; C08G 18/48; C08G 18/42; C08G 18/72

(57) ABSTRACT

A resin is provided, wherein the resin is formed by reacting 1 part by mole of a multi-isocyanate core with 3 to 4.5 parts by mole of diol to form an intermediate, and then reacting the intermediate with 3 to 4.5 parts by mole of first diisocyanate. The multi-isocyanate core can be a multi-isocyanate compound with more than two isocyanate groups. Alternatively, the multi-isocyanate core can be formed by reacting a second diisocyanate with a multi-hydroxy compound, and the multi-hydroxy compound has more than two hydroxy groups.

### CROSS REFERENCE TO RELATED APPLICATIONS

The present application is based on, and claims priority from, Taiwan Application Serial Number 107143845, filed on Dec. 6, 2018, the disclosure of which is hereby incorporated by reference herein in its entirety.

### TECHNICAL FIELD

The technical field relates to hot melt adhesive and a resin composition thereof.

### BACKGROUND

In all of the raw materials that are used in the manufacturing of shoes, the critical method of connecting the components to assemble the final product (i.e. the shoe) is to use an adhesive. In recent years, many countries in the world promote their own environmental protection laws to limit VOC emissions in the process. As such, the use of organic solvents should be prohibited or lowered during the manufacturing processes of shoes. The developments being made in the field of shoe manufacturing have obviously been toward the use of materials that are not a detriment to the environment while providing a rapid process, satisfying the requirements of automated manufacturing and a fast-changing market. The main technical developments in the adhesives used in shoes have been toward low pollution and high functionality. Low-polluting adhesives are based on aqueous resin or non-solvent resin, and the latter is derived to hot melt resin, powder resin, or UV resin. The polyurethane (PU) hot melt adhesive has advantages such as accelerating the production speed and lowering costs. The specialty chemical manufacturers whose products are used in shoe production (e.g. Bayer, Henkel, Bostik, and the like) have developed highly functional and room-temperature crosslinkable PU resins without solvent for shoes, and the above resins may have a green strength of 3 kgf/cm allowing them to be successfully applied to attach high functional shoe materials. In addition, the above resin may lower the amount of organic solvent to near zero VOC. However, conventional room temperature crosslinkable PU resins have problems such as high viscosity (at least 100,000 cps at 120° C.) and poor flowability. Accordingly, a novel adhesive that simultaneously meets the requirements of non-solvent, high adhesion strength, and low viscosity is called for.

### SUMMARY

One embodiment of the disclosure provides a resin, being formed by reacting 1 part by mole of a multi-isocyanate core with 3 to 4.5 parts by mole of diol to form an intermediate, and then reacting the intermediate with 3 to 4.5 parts by mole of first diisocyanate.

One embodiment of the disclosure provides a hot melt adhesive, including a resin, and the resin is formed by reacting 1 part by mole of a multi-isocyanate core with 3 to 4.5 parts by mole of diol to form an intermediate, and then reacting the intermediate with 3 to 4.5 parts by mole of first diisocyanate.

A detailed description is given in the following embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

One embodiment of the disclosure provides a resin formed by the following method. First, 3 to 4.5 parts by mole of second diisocyanate and 1 part by mole of multi-hydroxy compound are reacted at a temperature of 60° C. to 90° C. to form 1 part by mole of multi-isocyanate core with more than two isocyanate groups. If the reaction temperature of forming the multi-isocyanate core is too low, the reaction will be incomplete. If the reaction temperature forming the multi-isocyanate core is too high, the multi-isocyanate core will be randomly bridged to dramatically increase the viscosity of the resin. For example, the multi-hydroxy compound may have a chemical structure of

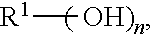

in which n is greater than 2, and R¹ is C₁₋₂₁ linear or branched alkyl group, or C₃₋₁₂ cycloalkyl group or alkylcycloalkyl group, and the alkyl group of the alkylcycloalkyl group can be linear or branched alkyl group. In one embodiment, R¹ is C₆₋₁₈ linear or branched alkyl group, or C₆₋₁₂ cycloalkyl group or alkylcycloalkyl group, and the alkyl group of the alkylcycloalkyl group is linear or branched alkyl group. In one embodiment, R¹ is C₉₋₁₂ linear or branched alkyl group. In one embodiment, the multi-hydroxy compound is free of aromatic group, which can be trimethylolpropane (TMP), trihydroxypropane, glycerol, pentaerythritol, erythritol, the like, or a combination thereof. For example, the second diisocyanate may have a chemical structure of

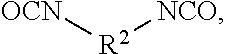

in which R² can be C₃₋₈ alkylene group or C₃₋₁₇ cycloalkylene group or alkylcycloalkylene group, and the alkyl group of the alkylcycloalkylene group can be linear or branched alkyl group. In one embodiment, the second diisocyanate is free of aromatic group, which can be isophorone diisocyanate (IPDI), pentamethylene diisocyanate (PDI), hexamethylene diisocyanate (HDI), dicyclohexylmethane 4,4-diisocyanate (H₁₂MDI), the like, or a combination thereof. If the amount of the second diisocyanate is too low, the hydroxy groups of the multi-hydroxy compound cannot be completely reacted, so that the final resin has an overly high viscosity due to the isocyanate groups of the multi-isocyanate core being decreased. The multi-isocyanate core can be formed by the following reaction:

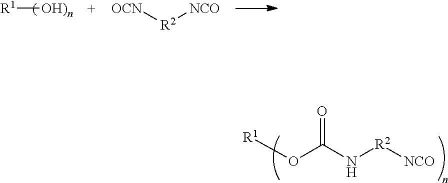

Thereafter, 1 part by mole of multi-isocyanate core and 3 to 4.5 parts by mole of diol are reacted to form an intermediate. If the diol amount is too low, it will form network between the resin molecules, thereby dramatically increasing the viscosity of the resin. If the diol amount is too high, the diol not reacted with the multi-isocyanate core should be removed in additional steps to avoid diluting the resin concentration. The reaction of forming the intermediate is performed at a temperature of 90° C. to 120° C. . If the reaction temperature is too low, the multi-isocyanate core cannot be completely reacted. If the reaction temperature is too high, the multi-isocyanate core will be randomly bridged to dramatically increase the viscosity of the resin. In one embodiment, the diol can be polyester diol, polyether diol, the like, or a combination thereof. The diol may have a weight average molecular weight of 2000 to 4000, such as greater than 2000 and less than or equal to 4000. If the diol has a Mw that is too low, the resin product will have insufficient green strength. If the diol has a Mw that is too high, the overall resin viscosity will be too high to operate. In one embodiment, the diol is crystalline diol. In one embodiment, the diol is high crystalline diol. For example, the polyester diol is free of aromatic group, which may have a chemical structure of

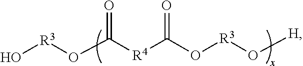

wherein x is the repeating number of the repeating unit (e.g. x=3-25), R³ is C₃₋₈ alkylene group or C₃₋₈ cycloalkylene group or alkylcycloalkylene group, and the alkyl group of the alkylcycloalkylene group can be linear or branched alkyl group. R⁴ is C₃₋₈ alkylene group or C₃₋₈ cycloalkylene group or alkylcycloalkylene group, and the alkyl group of the alkylcycloalkylene group can be linear or branched alkyl group. When the diol is polyester diol, the intermediate can be formed by the following reaction:

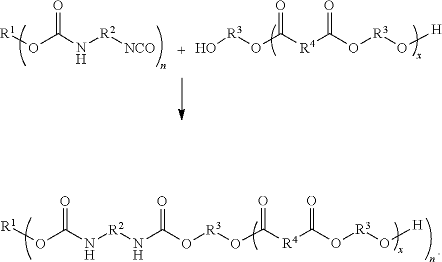

Alternatively, the diol is polyether diol without aromatic group, which may have a chemical structure of

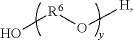

in which y is the repeating number of the repeating unit (e.g. y=8-75), and R⁶ is C₃₋₈ linear or branched alkylene group or C₃₋₈ cycloalkylene group or alkylcycloalkylene group, and the alkyl group of the alkylcycloalkylene group can be linear or branched alkyl group. When the diol is polyether diol, the intermediate can be formed by the following reaction:

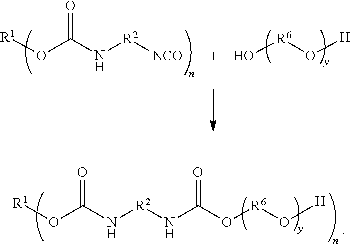

Thereafter, the intermediate and 3 to 4.5 parts by mole of first diisocyanate are reacted to form a resin with terminal isocyanate reactive groups. If the first diisocyanate ratio is too low, it will form network between the resin molecules, thereby dramatically increasing the viscosity of the resin. If the first diisocyanate ratio is too high, the first diisocyanate not reacted with the intermediate should be removed in additional steps to avoid diluting the resin concentration. In some embodiments, the reaction of forming the resin is performed at a temperature of 90° C. to 120° C. If the reaction temperature is too low, the multi-isocyanate core cannot be completely reacted. If the reaction temperature is too high, the multi-isocyanate core will be randomly bridged to dramatically increase the viscosity of the resin. The first diisocyanate may have a chemical structure of

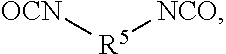

in which R⁵ can be C₃₋₈ alkylene group or C₃₋₈ cycloalkylene group or alkylcycloalkylene group, and the alkyl group of the alkylcycloalkylene group can be linear or branched alkyl group. In one embodiment, the first diisocyanate is free of aromatic group, which can be IPDI, PDI, HDI, dicyclohexylmethane 4,4-diisocyanate (H₁₂MDI), the like, or a combination thereof. The first diisocyanate and the above second diisocyanate can be the same or different. In other words, the resin is formed by reacting 1 part by mole of the multi-isocyanate core with 3 to 4.5 parts by mole of diol to form an intermediate, and then reacting the intermediate with 3 to 4.5 parts by mole of first diisocyanate, in which the multi-isocyanate core can be formed by reacting the multi-hydroxy compound and the second diisocyanate. When the diol for forming the intermediate is polyester diol, the resin can be formed by the following illustrative reaction:

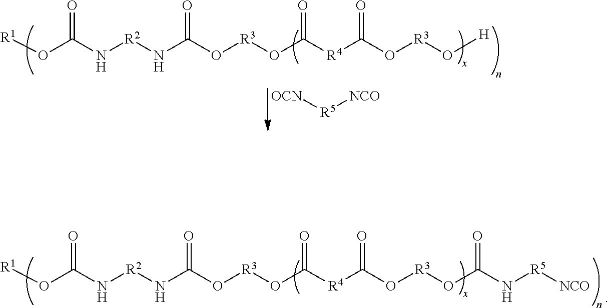

When the diol for forming the intermediate is polyether diol, the resin can be formed by the following illustrative reaction:

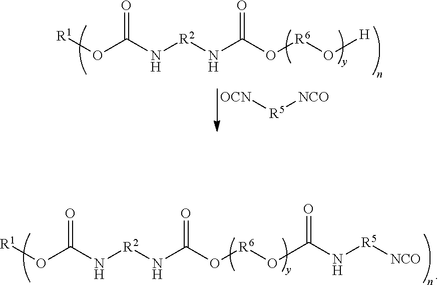

In one embodiment, the following steps can be sequentially performed: (1) the second diisocyanate and the multi-hydroxy compound are reacted to form a multi-isocyanate core, (2) the multi-isocyanate core and the diol are reacted to form an intermediate, and (3) the intermediate and the first diisocyanate are reacted to form the resin. In another embodiment, the diisocyanate (serving as first diisocyanate and second diisocyanate), multi-hydroxy compound, and diol are directly mixed in one pot, and the temperature of the mixture was adjusted to ensure that the above reactions are sequentially performed. The specific materials of the diisocyanate, the multi-hydroxy compound, and the diol are similar to above, and the related description is not repeated here. In the one-pot method, the first diisocyanate is same as the second diisocyanate. In the one-pot method, the number of moles of the diisocyanate and “the number of mole sum of the multi-hydroxy compound and the diol” have a ratio of 1.3:1 to 1.7:1. The molar ratio of the above compounds can be adjusted to prepare the resin with terminal isocyanate reactive groups.

Alternatively, the multi-isocyanate core is multi-isocyanate compound with more than two isocyanate groups. For example, the multi-isocyanate compound may have a structure of

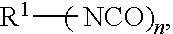

wherein n is greater than 2, R¹ is C₁₋₁₀ linear or branched alkyl group or C₃₋₁₈ cycloalkyl group or alkylcycloalkyl group, and the alkyl group of the alkylcycloalkyl group can be linear or branched alkyl group. In one embodiment, the multi-isocyanate compound is free of aromatic group, which can be isophorone diisocyanate (IPDI), pentamethylene diisocyanate, hexamethylene diisocyanate (HDI), dicyclohexylmethane 4,4′-diisocyanate, H₁₂MDI), the like, or a combination thereof. In one embodiment, the multi-isocyanate compound serves as the multi-isocyanate core, the polyester diol serves as the diol, and the intermediate can be formed by the illustrative formula:

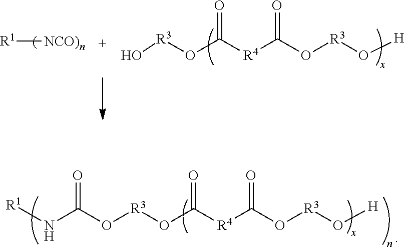

In such an embodiment, the intermediate and the first diisocyanate are reacted to form the resin as shown in the following formula:

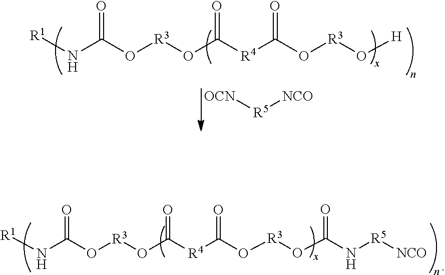

Alternatively, the multi-isocyanate compound serves as the multi-isocyanate core, the polyether diol serving as the diol, and the intermediate can be formed by the illustrative formula:

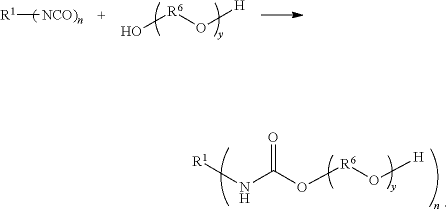

In such an embodiment, the intermediate and the first diisocyanate are reacted to form the resin as shown in the following formula:

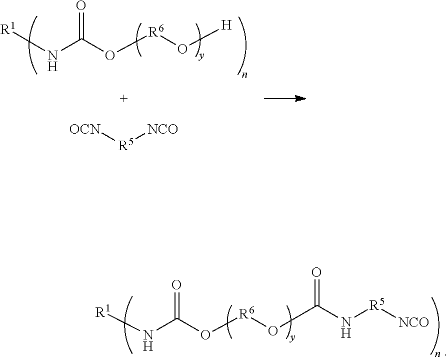

In one embodiment, the resin has a crystallinity of greater than 70%, which may efficiently enhance the mechanical strength of the resin. In general, the polyisocyanate-based resin has a crystallinity of less than 70%, so that the resin cannot be rapidly cured in an early process, and the attached resin does not have mechanical strength.

Note that the resin prepared by the above method may have a branched molecular structure, which may lower the viscosity of the resin. In addition, a diol with high crystallinity is introduced into the molecular structure of the resin to enhance the green strength of the hot melt adhesive.

One embodiment of the disclosure provides a hot melt adhesive, which includes the above resin. In some embodiments, the hot melt adhesive is free of solvent, meaning that the resin may directly serve as the hot melt adhesive. In some embodiments, the resin has a viscosity of 6000 cps to 15000 cps at 120° C. If the viscosity of the resin is too high, the resin will be partially cured before being coated on an object. If the viscosity of the resin is too low, the product will be degraded due to the resin may flow to a part that does not need to be coated by resin. In some embodiments, the hot melt adhesive is cured at a temperature of 10° C. to 30° C. under a relative humidity (RH) of 20% to 80%. For example, the hot melt adhesive can be rapidly cured at room temperature (e.g. 25° C.) under normal humidity (e.g. RH=75%).

Below, exemplary embodiments will be described in detail so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Example 1

3 parts by mole of polyester diol 7330 (Evonik Dynacoll 7330, Mw=3500) serving as diol, 1 part by mole of trimethylolpropane (TMP) serving as multi-hydroxy compound, and 7 parts by mole of hexamethylene diisocyanate (HDI) serving as first diisocyanate and second diisocyanate were mixed. The mixture was heated to 80° C. and reacted at 80° C. for 1 hour, so that TMP and a part of HDI (second diisocyanate) were reacted to form a multi-isocyanate core. Subsequently, the mixture was heated to 110° C. and reacted at 110° C. for 1 hour, so that the multi-isocyanate core and the polyester diol 7330 were reacted to form an intermediate. The mixture was adjusted to 100° C. and reacted at 100° C. for 1 hour, so that the intermediate and the other part of HDI (first diisocyanate) were reacted to from a resin. The resin has a viscosity of 14650 cps at 120° C. (measured by the standard ASTM-D3236). The green strength of the resin was 1.19 kgf/cm, and the final strength of the resin was 12.25 kgf/cm, which were measured by the standard ASTM-D1876. The resin had a crystallinity of 77.5%.

### Example 2

3 parts by mole of polyether diol 5602 (ETEROL-5602 commercially available from Eternal Materials Co. Ltd., Mw=3750) serving as diol, 1 part by mole of TMP serving as multi-hydroxy compound, and 7 parts by mole of HDI serving as first diisocyanate and second diisocyanate were mixed. The mixture was heated to 80° C. and reacted at 80° C. for 1 hour, so that TMP and a part of HDI (second diisocyanate) were reacted to form a multi-isocyanate core. Subsequently, the mixture was heated to 110° C. and reacted at 110° C. for 1 hour, so that the multi-isocyanate core and the polyether diol 5602 were reacted to form an intermediate. The mixture was adjusted to 100° C. and reacted at 100° C. for 1 hour, so that the intermediate and the other part of HDI (first diisocyanate) were reacted to from a resin. The resin has a viscosity of 32710 cps at 120° C. (measured by the standard ASTM-D3236). The green strength of the resin was 4.22 kgf/cm, and the final strength of the resin was 14.08 kgf/cm, which were measured by the standard ASTM-D1876. The resin had a crystallinity of 70.5%.

### Example 3

3 parts by mole of polyester diol PBA3000 (commercially available from Young Shun Chemical Co. Ltd., Mw=3000) serving as diol, 1 part by mole of HDI trimer (Desmodur N3300, commercially available from Covestro) serving as multi-isocyanate core, and 3 parts by mole of HDI serving as first diisocyanate were mixed. The mixture was heated to 100° C. and reacted at 100° C. for 1 hour, so that the multi-isocyanate core and the polyester diol PBA3000 were reacted to form an intermediate. The mixture was heated to 110° C. and reacted at 110° C. for 1 hour, so that the intermediate and HDI (first diisocyanate) were reacted to from a resin.

### Comparative Example 1

3 parts by mole of polyester diol PBA (commercially available from Young Shun Chemical Co. Ltd., Mw=2000) serving as diol, 1 part by mole of TMP serving as multi-hydroxy compound, and 7 parts by mole of HDI serving as first diisocyanate and second diisocyanate were mixed. The mixture was heated to 80° C. and reacted at 80° C. for 1 hour, so that TMP and a part of HDI (second diisocyanate) were reacted to form a multi-isocyanate core. Subsequently, the mixture was heated to 80° C. and reacted at 80° C. for 1 hour, so that the multi-isocyanate core and the polyester diol PBA were reacted to form an intermediate. The mixture was heated to 110° C. and reacted at 110° C. for 1 hour, so that the intermediate and the other part of HDI (first diisocyanate) were reacted to from a resin. The resin has a viscosity of 14650 cps at 120° C. (measured by the standard ASTM-D3236). The green strength of the resin was null, and the final strength of the resin was 8.13 kgf/cm, which were measured by the standard ASTM-D1876. The resin had a crystallinity of 56.0%. As shown in Comparative Example 1, the diol with overly low Mw resulted in insufficient green strength of the resin.

### Comparative Example 2

2 parts by mole of polyether diol 5602 (ETEROL-5602 commercially available from Eternal Materials Co. Ltd.) serving as diol, 1 part by mole of 1,4-butanediol serving as dihydroxy compound, and 2 parts by mole of HDI serving as first diisocyanate and second diisocyanate were mixed. The mixture was heated to 80° C. and reacted at 80° C. for 1 hour, so that 1,4-butanediol (dihydroxy compound) and a part of HDI (second diisocyanate) were reacted to form a diisocyanate core. Subsequently, the mixture was heated to 100° C. and reacted at 100° C. for 1.5 hours, so that the diisocyanate core and the polyether diol 5602 were reacted to form an intermediate. The mixture was heated to 110° C. and reacted at 110° C. for 1 hour, so that the intermediate and the other part of HDI (first diisocyanate) were reacted to from a resin. The resin has a viscosity of 86900 cps at 120° C. (measured by the standard ASTM-D3236). The green strength of the resin was 7.15 kgf/cm, and the final strength of the resin was 7.22 kgf/cm, which were measured by the standard ASTM-D1876. The resin had a crystallinity of 51.8%. As shown in Comparative Example 2, if the resin core was diisocyanate rather than multi-isocyanate, the resin viscosity would be too high to apply the resin to the object to be attached.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A resin, being:
formed by reacting 1 part by mole of a multi-isocyanate core with 3 to 4.5 parts by mole of diol to form an intermediate, and then reacting the intermediate with 3 to 4.5 parts by mole of first diisocyanate.

2. The resin as claimed in claim 1, wherein the multi-isocyanate core is a multi-isocyanate compound with more than two isocyanate groups.

3. The resin as claimed in claim 1, wherein the multi-isocyanate core is formed by reacting 3 to 4.5 parts by mole of a second diisocyanate with 1 part by mole of a multi-hydroxy compound, and the multi-hydroxy compound has more than two hydroxy groups.

4. The resin as claimed in claim 1, wherein the diol is polyether diol or polyester diol.

5. The resin as claimed in claim 1, wherein the diol has a weight average molecular weight of 2000 to 4000.

6. A hot melt adhesive, comprising a resin, and the resin is formed by reacting 1 part by mole of a multi-isocyanate core with 3 to 4.5 parts by mole of diol to form an intermediate, and then reacting the intermediate with 3 to 4.5 parts by mole of first diisocyanate.

7. The hot melt adhesive as claimed in claim 6, being free of solvent.

8. The hot melt adhesive as claimed in claim 6, being cured at a temperature of 10° C. to 30° C. under a relative humidity of 20% to 80%.
